(19) United States
(12) Patent Application Publication
(10) Pub. No.: US 2009/0148300 A1
(43) Pub. Date: Jun. 11, 2009

(54) MODULAR WIND TURBINE BLADES WITH RESISTANCE HEATED BONDS

(75) Inventors: Howard D. Driver, Greer, SC (US); Wendy W. Lin, Niskayuna, NY (US); Jamie T. Livingston, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/953,314

(22) Filed: Dec. 10, 2007

(51) Int. Cl. F03D 11/00

(52) U.S. Cl. 416/223 R

(57) ABSTRACT

A blade for a wind turbine includes a first structural component; a second structural component; and at least one conductive bond for joining the first and second structural components.

### CROSS REFERENCE TO RELATED APPLICATIONS

The subject matter of this application is generally related to that disclosed in copending U.S. patent application Ser. Nos. 11/311,053, filed on Dec. 19, 2005 as “Modularly Constructed Rotorblade and Method for Construction” (Attorney Docket Nos. 180916 and 182704); 11/380,936 filed on Apr. 30. 2006 as “Modular Rotor Blade For A Wind Turbine And Method For Assembling Same” (Attorney Docket No. 196356); and 11/854,867 filed on Sep. 14, 2007 as “Jig and Fixture for Wind Turbine Blade” (Attorney Docket No. 225490).

### BACKGROUND OF THE INVENTION

1. Technical Field

The subject matter described here generally relates to fluid reaction surfaces with specific blade structures, and, more particularly, to modular wind turbine blades with resistance heated bonds.

2. Related Art

A wind turbine is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

Wind turbines use one or more airfoils in the form of a “blade” or “rotorblade” to generate lift and capture momentum from moving air that is then imparted to a rotor. Each blade is typically secured at its “root” end, and then “spans” radially “outboard” to a free, “tip” end. The front, or “leading edge,” of the blade connects the forward-most points of the blade that first contact the air. The rear, or “trailing edge,” of the blade is where airflow that has been separated by the leading edge rejoins after passing, over the suction and pressure surfaces of the blade. A “chord line” connects the leading and trailing edges of the blade in the direction of the typical airflow across the blade. The length of the chord line is simply the “chord.”

Wind turbines are typically categorized according to the vertical or horizontal axis about which the blades rotate. One so-called “horizontal-axis wind generator” is schematically illustrated in FIG. 1 and available from GE Energy of Atlanta, Ga. USA. This particular configuration for a wind turbine 2 includes a tower 4 supporting a drive train 6 with a rotor 8 that is covered by a protective enclosure referred to as a “nacelle.” The blades 10 are arranged at one end of the rotor 8, outside the nacelle, for driving a gearbox 12 that is connected to an electrical generator 14 at the other end of the drive train 6 along with a control system 16.

As wind turbine blades increase in size, so has the cost of transporting the blades to the turbine site. Conventional approaches to this problem have included building factories near windy installation sites in order to minimize ground travel, segmenting the blades so as to reduce the length of the shipped components, and shipping unassembled blade parts for assembly at the installation site. For example, U.S. patent application Ser. No. 11/311,053 (Attorney Docket Nos. 180916 and 182704), filed on Dec. 19, 2005, discloses a “Modularly Constructed Rotorblade and Method for Construction” illustrated in FIG. 2. Bonding lines 18 and 20 are representative of a seam or region at which the plurality of rotorblade sections are bonded. The rotorblade 10 may include any number of bonding lines and corresponding rotorblade sections, and the bonding lines may be disposed in any direction, parallel, perpendicular, or otherwise related to the leading edge and the trailing edge. As illustrated in FIG. 3, each of the sections may include at least one flange 25 that is bonded via an adhesive 23.

However, conventional methods for attaching these and other wind turbine blades components are generally quite complex and time-consuming. For example, they often require specialized equipment, such as ovens, heat tents, and heater blankets, in order to maintain the adhesive materials at an appropriate temperate while curing a wide range of environmental conditions at the construction site.

### BRIEF DESCRIPTION OF THE INVENTION

These and other aspects of such conventional approaches are addressed here by providing, in various embodiments, a blade for a wind turbine, including a first structural component; a second structural component; and at least one conductive bond for joining the first and second structural components.

### BRIEF DESCRIPTION OF THE DRAWINGS

Various aspects of this technology invention will now be described with reference to the following figures (“FIGs.”) which are not necessarily drawn to scale, but use the same reference numerals to designate corresponding parts throughout each of the several views.

FIG. 1 is a schematic side view of a conventional wind turbine.

FIG. 2 is a side perspective view of a modularly constructed rotorblade.

FIG. 3 is an enlarged schematic cross-section of a conventional joint for a wind turbine blade bonding line from FIG. 2.

FIG. 4 is a schematic cross-section of a joint for a wind turbine blade.

FIG. 5 is a schematic cross-section of a joint for a wind turbine blade.

FIG. 6 is a schematic cross-section of a joint for a wind turbine blade.

### DETAILED DESCRIPTION OF THE INVENTION

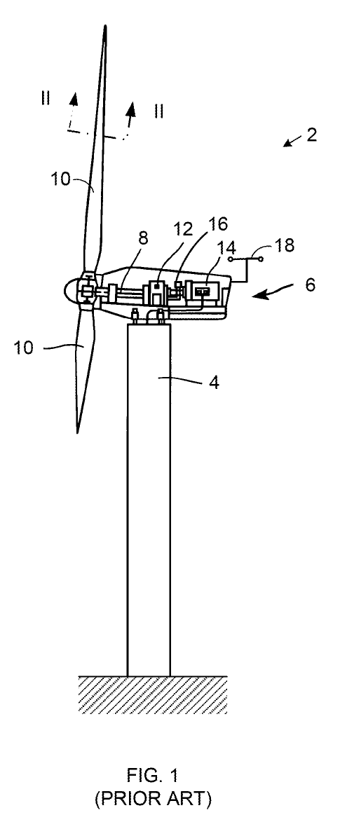

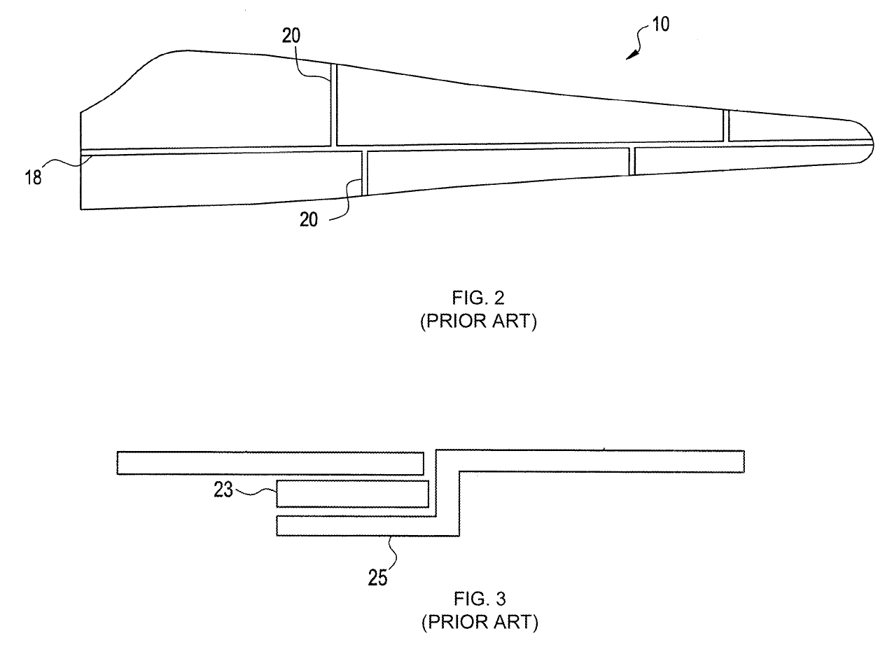

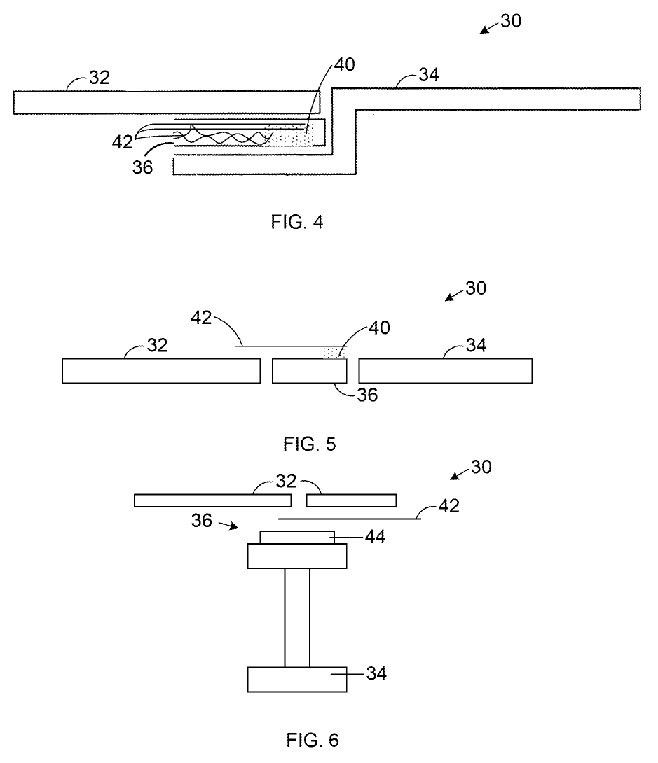

FIG. 4 is an enlarged schematic cross-section of a joint 30 for the wind turbine blade 10 shown in FIG. 1. For example, the blade 10 shown in Figures may be constructed with the joint 30 and/or modified to include any of the various features discussed below. Although a lap joint is depicted in FIG. 4, any other type of joint may also be used including, but not limited to biscuit, bridle, butterfly, dowel, coping, cope and stick, dado, housing, dovetail, finger, box combing, lap, cross-lap, halved, dovetail-lap, end-lap, halving joint, middle-lap, miter, mortise and tenon, pocket-hole, rabbet or rebate, scarf or scarph, splice, tongue and groove, frame and panel, rail and style, splice, half-lap splice, table splice, and bevel lap splice joints.

In FIG. 4, a first structural component 32 is joined to a second structural component 34 by at least one conductive bond 36 for joining the first and second structural components. The conductive bond 36 is configured to distribute energy across the bonding media and/or adherent. For example, the conductive bond may include a conductive material and an adhesive material such as a material selected from the group consisting of a thermoplastic material and a thermosetting resin.

The conductive material may include non-metallic and/or metallic material and/or the adhesive may include conductive (non-metallic) polymers. For example, the non-metallic conductive materials may include carbon fibers, non-metallic thermoplastic filaments/fibers, carbon nanotubes, and/or ceramic powders and whiskers. The metallic material may be powdered metal 40 and/or one or more (metallic and/or non-metallic) wires 42 embedded in the thermosetting resin or thermoplastic material. As illustrated in FIG. 4, some or all of the wires 42 may be braided, stitched, and/or otherwise woven together, and some or all of the wires may extend from the conductive bond 36. For example, the stitches may be made of conductive or non-conductive fibers. The conductive material may also be in the form of a foil, plate, web, cloth, sheet, strip, tape, ribbon, strand, and/or filament including, but not limited to, Grafoil® brand materials available from Union Carbide Corporation and others.

As illustrated in the butt joint of FIG. 5, in addition to being embedded, the metallic wires 42 illustrated here, may be laid over and/or under the thermosetting resin and/or thermoplastic material in the conductive bond 36. FIG. 6 illustrates another embodiment where the first structural component 32 includes a thermoplastic skin with a gap, and the second structural 34 component comprises thermosetting substructure for supporting the skin. The conductive bond 36 includes a strip of thermoplastic material 44 secured to the thermosetting substructure 34 for filling the gap.

Once in place, the conductive bond 36 can be heated with an electromagnetic energy source that focuses energy on the region of the joint 30. For example, the wires 42 can be connected to a current source, such as a 48 Volt battery or generator, that causes an electrical current to flow conductive bond 36 and heat the surrounding thermoplastic and/or thermosetting material. However, other energy sources may also be used, including induction and/or infra-red heat sources.

The technology described above facilitates on-site assembly of wind turbines by focusing the heat energy in the conductive bond 36 of the blade 10 where it is needed to properly set and/or cure the materials in the bond. Focusing this heat energy helps to minimize and/or avoid the need for traditional heating equipment such as ovens, heat tents, and heater blankets that might otherwise have to heat the entire blade structure. The technology described here also helps to avoid loss of heat to surrounding structures in the blade 10 that would otherwise require larger energy sources in order to maintain the appropriate temperature of the bond 36.

The various embodiments described above provide enhanced buckling resistance for wind turbine blades. It should be emphasized that the embodiments described above, and particularly any “preferred” embodiments, are merely examples of various implementations that have been set forth here to provide a clear understanding of various aspects of this technology. It will be possible to alter many of these embodiments without substantially departing from scope of protection defined solely by the proper construction of the following claims.

What is claimed is:

1. A blade for a wind turbine, comprising:
a first structural component;
a second structural component; and
at least one conductive bond for joining the first and second structural components.

2. The blade recited in claim 1 wherein the at least one conductive bond comprises a conductive material and a material selected from the group consisting of a thermoplastic material and a thermosetting resin.

3. The blade recited in claim 2 wherein the conductive material is embedded in the thermosetting resin.

4. The blade recited in claim 2 wherein the conductive material comprises a at least one wire.

5. The blade recited in claim 4 wherein the at least one wire comprises a plurality of metallic wires that are woven together.

6. The blade recited in claim 2 wherein the conductive material is laid over the thermosetting resin.

7. The blade recited in claim 6 wherein the conductive material comprises at least one of wires.

8. The blade recited in claim 7 wherein the at least one wire comprises a plurality of metallic wires that are woven together.

9. The blade recited in claim 1 wherein the first structural component comprises a thermoplastic skin and the second structural component comprises thermosetting substructure for supporting the skin.

10. The blade recited in claim 9, wherein the at least one bond further comprises a strip of thermoplastic material secured to the thermosetting substructure.

11. A wind generator, comprising:
a tower for supporting a drive train with a rotor;
a gearbox, connected to the rotor, for driving an electrical generator;
at least one blade, connected to the rotor, for driving the gearbox;
wherein the blade comprises:
a first structural component;
a second structural component; and
at least one conductive bond for joining the first and second structural components.

12. The wind generator recited in claim 11 wherein the at least one conductive bond comprises a conductive material and a material selected from the group consisting of a thermoplastic material and a thermosetting resin.

13. The wind generator recited in claim 12 wherein the conductive material is embedded in the thermosetting resin.

14. The wind generator recited in claim 12 wherein the conductive material comprises at least one wire.

15. The wind generator recited in claim 14 wherein the at least one wire comprises plurality of metallic wires that are woven together.

16. The wind generator recited in claim 12 wherein the conductive material is laid over the thermosetting resin.

17. The wind generator recited in claim 16 wherein the conductive material comprises at least one wire.

18. The wind generator recited in claim 17 wherein the at least one wire comprises a plurality of metallic wires that are woven together.

19. The wind generator recited in claim 11 wherein the first structural components comprises a thermoplastic skin and the second structural component comprises thermosetting substructure for supporting the skin.

20. The wind turbine blade recited in claim 19, wherein the at least one bond further comprises a strip of thermoplastic material secured to the thermosetting substructure.
